(19) United States
(12) Patent Application Publication
(10) Pub. No.: US 2016/0116680 A1
(43) Pub. Date: Apr. 28, 2016

(54) LIGHT COUPLING STRUCTURE AND OPTICAL DEVICE INCLUDING A GRATING COUPLER

(71) Applicant: Tyco Electronics Corporation, Berwyn, PA (US)

(72) Inventors: Tao Ling, Harrisburg, PA (US); Jonathan Lee, Harrisburg, PA (US)

(21) Appl. No.: 14/523,349

(22) Filed: Oct. 24, 2014

(51) Int. Cl. G02B 6/34; G02B 6/30; G02B 6/125; G02B 5/18

(52) U.S. Cl. CPC G02B 6/34; G02B 5/1809; G02B 6/305; G02B 6/125

(57) ABSTRACT

Light-coupling structure including a grating coupler that is configured to optically couple with an optical element. The grating coupler has a diffraction grating that extends parallel to a grating plane. The grating coupler is configured to diffract a light beam into first and second diffracted portions when the light beam is effectively normal to the grating plane. The first and second diffracted portions propagate away from each other. The light-coupling structure also includes first and second intermediate waveguides that are optically coupled to the grating coupler and configured to receive the first and second diffracted portions, respectively. The light-coupling structure also includes a common waveguide that is coupled to the first and second intermediate waveguides at a waveguide junction. The first and second diffracted portions propagate within the first and second intermediate waveguides, respectively, and are combined in-phase at the waveguide junction.

### BACKGROUND

The subject matter herein relates generally to an optical device that is configured to optically couple with another element, such as an optical fiber or laser, through a grating coupler.

Recently, more and more industries have begun to use optical devices and, in particular, optical devices developed through silicon photonics. For example, photonic integrated circuits (PICs) may be used for various applications in optical communications, instrumentation, and signal-processing fields. A PIC may use submicron waveguides to interconnect various on-chip components, such as optical switches, couplers, routers, splitters, multiplexers/demultiplexers, modulators, amplifiers, wavelength converters, optical-to-electrical signal converters, and electrical-to-optical signal converters. One advantage that PICs have is the potential for large-scale manufacturing and integration through known semiconductor fabrication techniques (e.g., complementary metal-oxide-semiconductor (CMOS)).

A PIC may be optically coupled to an external optical fiber or a light source such that the PIC may receive light from the optical fiber or the light source and/or direct light into the optical fiber. However, it can be challenging to optically couple the optical fiber and the PIC in an efficient manner, such as greater than 50% efficiency. For instance, the optical fiber has a cross-sectional area that is much larger than the cross-sectional area of the submicron waveguide of the PIC. Thus, the mode-field cross-sectional area must be significantly reduced as the light transitions from the optical fiber to the PIC or vice versa.

The two most common light-coupling solutions are in-plane coupling and out-of-plane coupling. In-plane coupling, which may also be referred to as edge coupling or butt coupling, includes orienting the optical fiber such that an end of the optical fiber is aligned with a central axis of the waveguide. In other words, the end of the optical fiber is “in-plane” with the waveguide. Although in-plane coupling can be efficient and can effectively reduce the mode-field diameter, PICs that utilize in-plane coupling can be difficult to manufacture, package, and test for quality control.

In out-of-plane coupling, the optical fiber is not aligned with the central axis or the plane of the waveguide. Instead, the axis of the optical fiber is almost normal to the plane of the waveguide. Out-of-plane coupling may be accomplished through grating couplers. A grating coupler includes a planar grating that is oriented almost normal to the axis of the optical fiber. The grating is configured to scatter the light in a manner that propagates the light in the desired direction (i.e., into the waveguide of the PIC or into the optical fiber).

Grating couplers are generally more tolerant to misalignment and lend themselves to less packaging complexity. At least for certain applications, however, PICs that include grating couplers are typically less efficient than PICs that include in-plane coupling. Moreover, aligning the PIC and the optical fiber can still be challenging. For example, it is often necessary to orient the optical fiber such that the optical fiber is not perfectly normal with respect to the grating. For example, the optical fiber is typically positioned within about 9.0° to about 12.0° with respect to normal. For some applications, it may be difficult to reliably position the optical fiber in this orientation.

Accordingly, there is a need for a light-coupling structure having a grating coupler that is capable of coupling with a light beam that is effectively normal with respect to the grating coupler.

### BRIEF DESCRIPTION

In an embodiment, a light-coupling structure is provided. The light-coupling structure includes a grating coupler that is configured to optically couple with an optical element. The grating coupler has a diffraction grating that extends parallel to a grating plane. The grating coupler is configured to diffract a light beam into first and second diffracted portions when the light beam is directed from the optical element to the grating coupler and is effectively normal to the grating plane. The first and second diffracted portions propagate away from each other. The light-coupling structure also includes first and second intermediate waveguides that are optically coupled to the grating coupler and configured to receive the first and second diffracted portions, respectively, from the grating coupler. The light-coupling structure also includes a common waveguide that is coupled to the first and second intermediate waveguides at a waveguide junction. The first and second diffracted portions propagate within the first and second intermediate waveguides, respectively, and are combined in-phase at the waveguide junction.

In some embodiments, the light beam is effectively normal with respect to the grating plane when the light beam is within about 6.0° of being normal with respect to the grating plane.

In some embodiments, the first and second intermediate waveguides are formed from a waveguide layer. The waveguide layer also forms a light-coupling portion that extends alongside the diffraction grating. The diffraction grating is configured to direct the first and second diffracted portions into the light-coupling portion. The first and second diffracted portions propagate in the opposite directions within the light-coupling portion. Optionally, the grating coupler includes a cladding layer that extends alongside the waveguide layer. The diffraction grating may be embedded within the cladding layer such that a portion of the cladding layer extends between the diffraction grating and the waveguide layer. Optionally, the diffraction grating is separated from the waveguide layer by a cladding sub-layer.

In some embodiments, the diffraction grating has a grating period that is less than a wavelength of the light beam. For example, the diffraction grating may have a grating period that is less than 1000 nanometers.

In an embodiment, an optical device is provided that includes a grating coupler that is configured to optically couple with an optical element. The grating coupler has a diffraction grating that extends parallel to a grating plane. The grating coupler is configured to diffract a light beam into first and second diffracted portions when the light beam is directed from the optical element to the grating coupler and is effectively normal to the grating plane. The first and second diffracted portions propagate away from each other. The optical device also includes first and second intermediate waveguides that are optically coupled to the grating coupler and configured to receive the first and second diffracted portions, respectively, from the grating coupler. The optical device also includes a common waveguide that is coupled to the first and second intermediate waveguides at a waveguide junction. The first and second diffracted portions propagate within the first and second intermediate waveguides, respectively, and are combined in-phase at the waveguide junction to form a guided portion. The optical device also includes an optical circuit that is optically coupled to the common waveguide. The optical circuit is configured to process the guided portion in a designated manner.

Optionally, the optical device is a photonic integrated circuit. Optionally, the optical circuit includes a modulator.

### BRIEF DESCRIPTION OF THE DRAWINGS

FIG. 1 is a schematic illustration of an optical device formed in accordance with an embodiment that is configured optically couple to an out-of-plane optical element.

FIG. 2 is a schematic illustration of a light-coupling structure of the optical device of FIG. 1 that may couple to the out-of-plane optical element.

FIG. 3 illustrates a side view of a grating coupler that may be used with the light-coupling structure of FIG. 2.

FIG. 4 is an isolated view of a coupling-transition region of the light-coupling structure of FIG. 2.

FIG. 5 illustrates a cross-section of the coupling-transition region.

### DETAILED DESCRIPTION

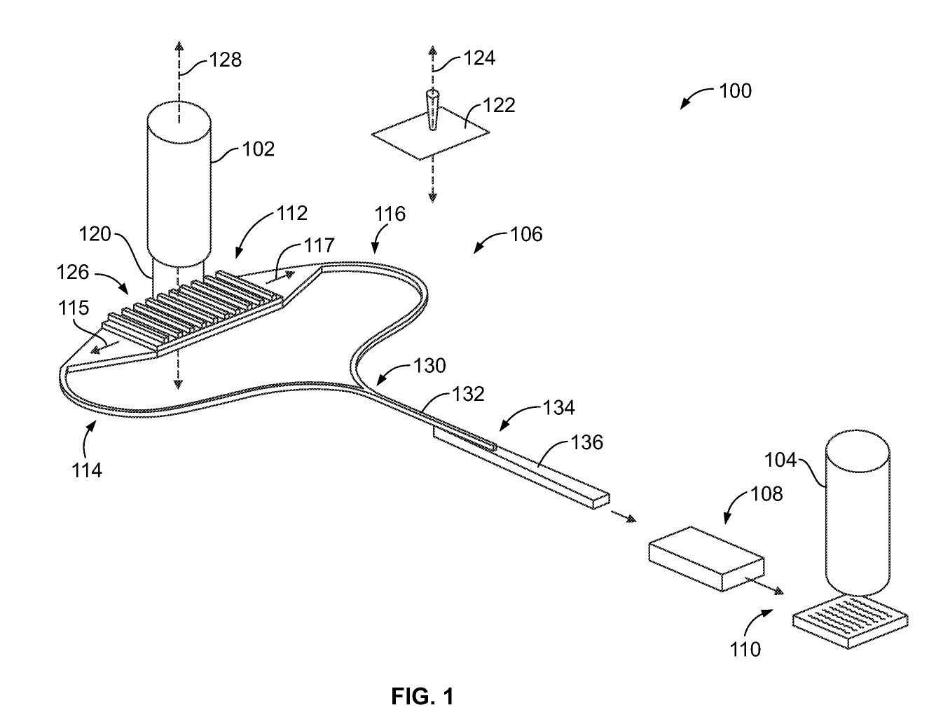

FIG. 1 is a schematic illustration of an optical device 100 formed in accordance with an embodiment. The optical device 100 may be configured to receive light (or light signals), process or modulate the light in a designated manner, and then emit the processed or modulated light. The light may be, for example, optical data signals. In an exemplary embodiment, the optical device 100 is a photonic integrated circuit (PIC) that is used for communicating and/or processing the optical signals. However, it should be understood that the optical device 100 may be used in other applications. For example, the optical device 100 may be a sensor having a sample that modulates the light signals and/or emits light signals based on properties of the sample.

In some embodiments, the optical device 100 is an integrated device that includes a silicon photonics chip. At least a portion of the optical device 100 may be fabricated with processes that are used to manufacture semiconductors. For example, the optical device 100 may be manufactured using processes that produce complementary metal-oxide-semiconductor (CMOS) devices and/or silicon-on-insulator (SOI) devices. In particular embodiments, the entire optical device 100 is manufactured using CMOS or SOI processes. The optical device 100 may be incorporated into a larger system or device.

As shown in FIG. 1, the optical device 100 is configured to optically couple a first optical element 102 and a second optical element 104. The optical device 100 may be bi-directional in some embodiments. Accordingly, although the following description may use directional terms when describing the propagation of light, it is understood that, in some embodiments, the light may propagate in the opposite direction. In the illustrated embodiment, the first and second optical elements 102, 104 are optical fibers that may provide the light to and/or receive the light from the optical device 100. In other embodiments, however, the first and second optical elements 102, 104 may be other types of optical elements that are capable of at least one of providing or receiving light. For example, either of the optical elements 102, 104 may be a light source or a light receiver. In some embodiments, a light source may include, for example, an optical fiber, a polarization controlled vertical-cavity surface-emitting laser (VCSEL), and/or a distributed feedback laser (DFB).

The optical device 100 includes a first light-coupling structure 106 that is optically coupled to an optical circuit 108 and/or a second light-coupling structure 110. The second light-coupling structure 110 is optically coupled to the second optical element 104. The optical circuit 108 and the light-coupling structure 110 are illustrated generically in FIG. 1, as it should be understood that a variety of optical circuits and/or light-coupling structures may be used. For example, the light-coupling structure 110 may be similar or identical to the light-coupling structure 106. The optical circuit 108 may be configured to process the light (or light signals) propagating through the optical device 100 in a predetermined manner. Non-limiting examples of applications for the optical device 100 or the optical circuit 108 include optical switches, couplers, routers, splitters, modulators, amplifiers, multiplexers/demultiplexers, wavelength converters, optical-to-electrical, and electrical-to-optical signal converters. In other embodiments, the optical circuit 108 may be part of a sensor that is configured to detect one or more properties of an environment or of a sample.

In an exemplary embodiment, the light-coupling structure 106 is an in-coupling structure that receives a light beam 120 from the first optical element 102, and the light-coupling structure 110 is an out-coupling structure that provides the modulated light to the second optical element 104. In some embodiments, however, the optical device 100 may be configured to propagate light in the opposite direction from the light-coupling structure 110 to the light-coupling structure 106.

The light-coupling structure 106 includes a grating coupler 112 and first and second intermediate waveguides 114, 116. The grating coupler 112 is optically coupled to the optical element 102 such that the light beam 120 received from the optical element 102 is separated into first and second diffracted portions that are directed in opposite first and second directions (represented as arrows 115, 117). As such, the grating coupler 112 may be described as a one-dimensional (1D) grating coupler. The first and second diffracted portions of the light beam 120 are directed into the first and second intermediate waveguides 114, 116, respectively. The first and second diffracted portions are transmitted along the respective first and second intermediate waveguides 114, 116 and joined or re-coupled at a waveguide junction 130 or an optical combiner (e.g., multimode interference structure). The waveguide junction 130 is configured to join the first and second diffracted portions in-phase such that the first and second diffracted portions form a combined light within a common waveguide 132. The combined first and second diffracted portions are referred to as a guided portion or a combined portion. The guided portion may then propagate along the common waveguide 132 to a coupling-transition region 134. The coupling-transition region 134 includes a device waveguide 136 that directs the guided portion to the optical circuit 108.

As described herein, the light-coupling structure 106 is configured to receive the light beam 120 from the first optical element 102. Unlike conventional grating couplers, the light beam 120 may be effectively normal or perpendicular to a grating plane 122, such as within 6.0° of a normal axis 124. The grating plane 122 may represent a plane that extends parallel to one or more layers of the light-coupling structure 106. For example, the grating coupler 112 includes a grating 126 having a variation or modulation in refractive index that extends parallel to the grating plane 122. The refractive index variation may be periodic throughout or include a plurality of portions that vary at different frequencies.

FIG. 1 illustrates the grating plane 122 with respect to the normal axis 124. The light beam 120 emitted from the optical element 102 and/or the light received from the optical element 102 may propagate along a light-propagating axis 128. In some embodiments, the light-propagating axis 128 may coincide with a central axis of an end of an optical fiber. For reference, the light-propagating axis 128 is shown extending through a center of the optical element 102. The optical element 102 and/or the optical device 100 are positioned such that light-propagating axis 128 is effectively normal with respect to the grating plane 122. In other words, the light-propagating axis 128 may extend effectively parallel to the normal axis 124.

Due to tolerances in the manufacturing of the optical device 100 and/or the optical element 102, it may be difficult to position the optical element 102 such that the light-propagating axis 128 is perfectly normal with respect to the grating coupler 112 or the grating plane 122. Embodiments set forth herein may orient the light-coupling structure 106 and/or the optical element 102 relative to each other such that the light-propagating axis 128 may be effectively normal with respect to the grating coupler 112 or the grating plane 122. Embodiments herein may be “effectively normal” if the light-propagating axis 128 is 6.0° or less from being perfectly normal with respect to the grating coupler 112 or the grating plane 122. In particular embodiments, the light-propagating axis 128 is effectively normal if the light-propagating axis 128 is 5.0° or less, 4.0° or less, or 3.0° or less from being perfectly normal with respect to the grating coupler 112 or the grating plane 122. In more particular embodiments, the light-propagating axis 128 may be 2.5° or less, 2.0° or less, 1.5° or less, 1.0° or less, or 0.5° or less from being perfectly normal with respect to the grating coupler 112 or the grating plane 122. The cone shown with respect to the normal axis 124 and the grating plane 122 may represent permitted tolerances of the light-propagating axis 128.

Embodiments set forth herein may be unlike conventional light-coupling structures that intentionally tilt an optical fiber relative to the normal axis of the grating coupler. Conventional light-coupling structures typically tilt the light-propagating axis with respect to the normal axis by 9° or more to, among other things, increase the coupling efficiency. Despite the light-propagating axis 128 being effectively normal with respect to the grating coupler 112 or the grating plane 122, embodiments may be capable of achieving a reasonable coupling efficiency. For example, in some embodiments, a coupling efficiency between the optical element 102 and the grating coupler 112 and/or the optical device 100 may be at least 50% when the light-propagating axis 128 is effectively normal with respect to the grating plane 122. In particular embodiments, the coupling efficiency may be at least 60% or at least 70%. In more particular embodiments, the coupling efficiency may be at least 75% or at least 80%.

In some embodiments, the optical device 100 and/or the light-coupling structure 106 includes a plurality of substrate layers that are stacked over each other. For example, the light-coupling structure 106 may include a series of substrate layers having different refractive indices that are configured to control light as set forth herein. By way of example, the substrate layers may include one or more layers of silicon oxide, one or more layers of silicon nitride, one or more layers silicon oxynitride (SiON), one or more layers of silicon rich oxide, one or more layers of a silicon substrate, and one or more buried oxide layers. As described herein, the optical device 100 and/or the light-coupling structure 106 may be manufactured using semiconductor fabrication processes. For example, the substrate layers may be provided using processes that are used in CMOS and/or SOI technologies.

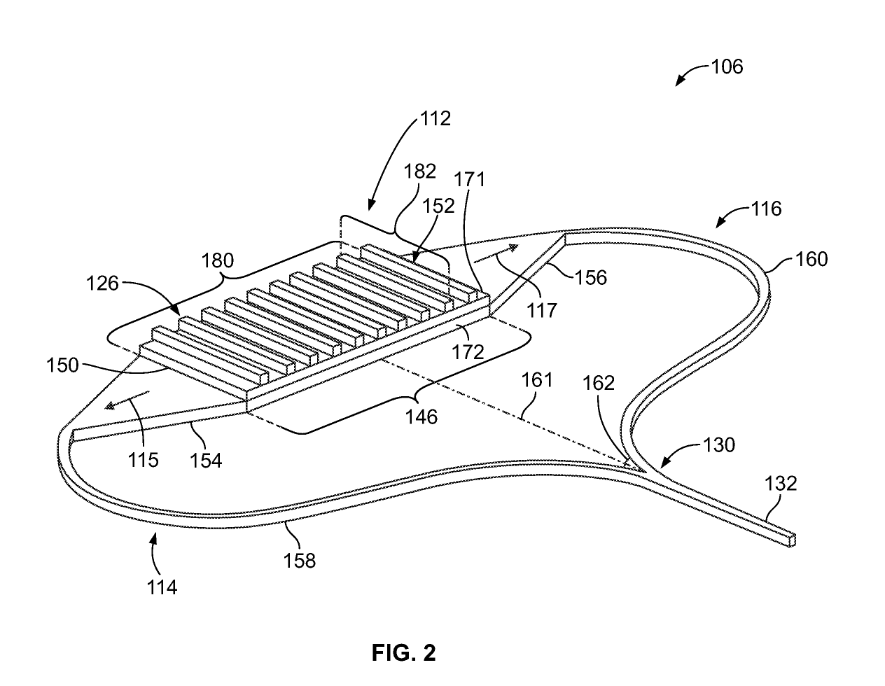

FIG. 2 is an enlarged view of the light-coupling structure 106 formed in accordance with an embodiment. As shown, the grating coupler 112 includes the diffraction grating 126 and a separation or cladding layer 171. Optionally, the diffraction grating 126 is embedded within the cladding layer 171. The light-coupling structure 106 also includes a waveguide layer 172 that is positioned adjacent to the grating coupler 112. The waveguide layer 172 is configured to receive the light from and/or provide the light to the grating coupler 112. In the illustrated embodiment, at least a portion of the cladding layer 171 interfaces with the waveguide layer 172 and separates the diffraction grating 126 from the waveguide layer 172. In some embodiments, the cladding layer 171 may also form part of the diffraction grating 126.

In the illustrated embodiment, the waveguide layer 172 is shaped to include a light-coupling portion 146 and the first and second intermediate waveguides 114, 116. The light-coupling portion 146 is stacked with respect to the cladding layer 171 and the diffraction grating 126. The first and second intermediate waveguides 114, 116 are coupled to opposite sides or ends 150, 152 of the light-coupling portion 146 or the grating coupler 112. Optionally, the light-coupling portion 146 may have an area that is at least equal to the grating coupler 112. For example, the grating coupler 112 extends along a first dimension 180 and a second dimension 182. The first and second dimensions 180, 182 are perpendicular to each other and may define an area of the grating coupler 112.

As described above, when the light beam 120 (FIG. 1) is incident on the diffraction grating 126, the diffraction grating 126 may separate the light beam 120 into the first and second diffracted portions that propagate in the opposite first and second directions 115, 117. The first and second intermediate waveguides 114, 116 include first and second mode-conversion segments 154, 156, respectively, and first and second path segments 158, 160, respectively. The first and second mode-conversion segments 154, 156 are configured to reduce the cross-sectional area of the waveguide layer 172 from a size that is comparable to the size of the beam spot or the grating coupler 112 to a size that is equal to cross-sectional areas of the first and second path segments 158, 160. The first and second path segments 158, 160 may have submicron cross-sectional dimensions. In the illustrated embodiment, the first and second mode-conversion segments 154, 156 are in-plane adiabatic tapers.

Each of the first and second path segments 158, 160 has a designated length that is measured from the corresponding mode-conversion segment to the waveguide junction 130. The first and second path segments 158, 160 may also have a designated path shape or contour. For example, the first and second path segments 158, 160 are substantially S-shaped. In an exemplary embodiment, the lengths of the first and second path segments 158, 160 are effectively equal and the first and second path segments 158, 160 may have identical shapes. As such, the first and second path segments 158, 160 may be effectively symmetrical with respect to a plane 161 that extends between the waveguide junction 130 and a center of the grating coupler 112. The plane 161 may extend parallel to the normal axis 124 (FIG. 1) and perpendicular to the grating coupler 112. In other embodiments, however, the lengths and/or the shapes of the path segments 158, 160 may be different such that the diffracted portions of the light are in-phase when combined through the waveguide junction 130.

As shown, the waveguide junction 130 may be a Y-junction. The first and second path segments may 158, 160 may extend into the waveguide junction 130 at an angle 162. The angle 162 may be, for example, less than 20°. The first and second path segments 158, 160 may combine to form the common waveguide 132. The common waveguide 132 may have a cross-sectional area that is similar or identical to the first and second path segments 158, 160 of the first and second intermediate waveguides 114, 116.

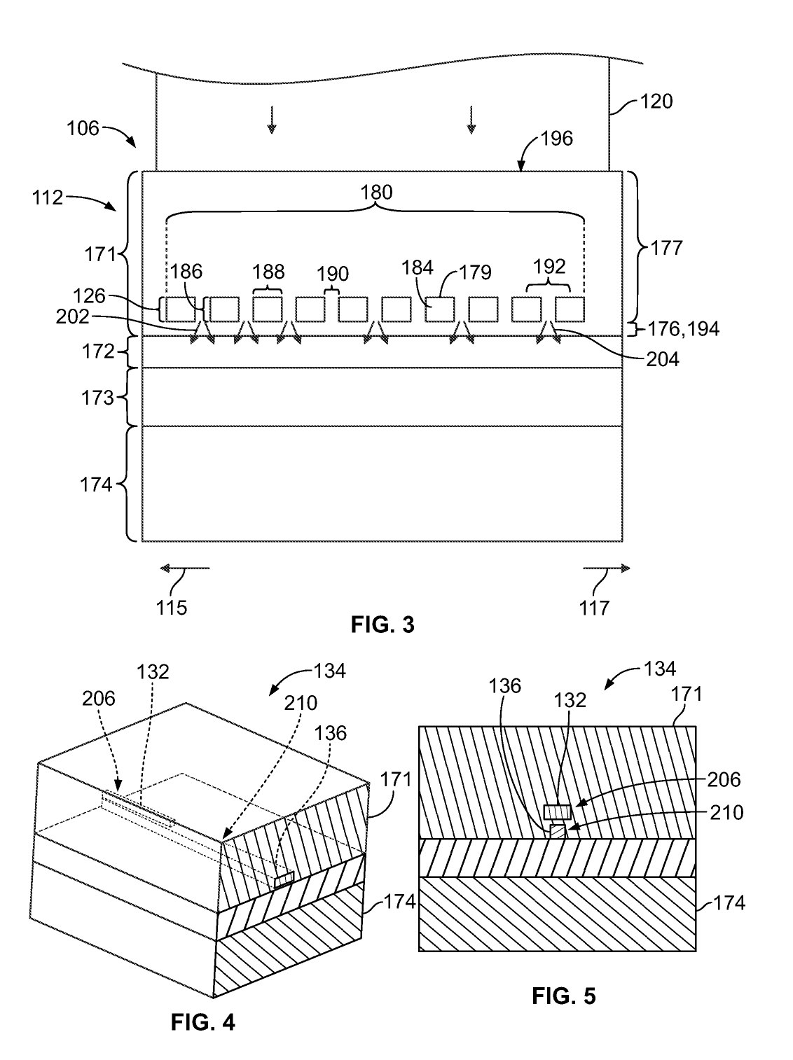

FIG. 3 is side view of a portion of the light-coupling structure 106 that includes the grating coupler 112. The optical device 100 (FIG. 1) and/or the light-coupling structure 106 may be formed from multiple substrate layers 171-174 stacked over each other. Each of the substrate layers 171-174 may engage or couple to one or two adjacent substrate layers along corresponding interfaces. In the illustrated embodiment, the light-coupling structure 106 includes the cladding layer 171, the diffraction grating 126, the waveguide layer 172, a cladding layer 173, and a base layer 174. The substrate layers 171-174 are formed from materials having refractive indices that enable or allow the light to propagate through the light-coupling structure 106 as described herein. As an example, the cladding layer 171 may comprise silicon oxide, the waveguide layer 172 may comprise silicon nitride, the cladding layer 173 may comprise silicon oxide, and the base layer 174 may comprise silicon. The substrate layers 171-174 may have refractive indexes of about 1.45, 2.0, 1.45, and 3.5, respectively. The differences in refractive indexes are configured to direct the propagating light along the waveguide layer 172.

Each of the substrate layers 171-174 may include a single layer or a plurality of sub-layers. For example, the cladding layer 171 may include a first cladding sub-layer 176 that extends between the diffraction grating 126 and the waveguide layer 172 and a second cladding sub-layer 177 that is formed along the diffraction grating 126. For example, after the first cladding sub-layer 176 is formed, the second cladding sub-layer 177 and the diffraction grating 126 may be subsequently formed on top of the first sub-layer 176. The first sub-layer 176 may have a refractive index that is lower than the refractive index of the waveguide layer 172 or the refractive index of the grating material 179. The second sub-layer 177 may include a single layer or multiple sub-layers.

The diffraction grating 126 may be formed in various manners before, after, or concurrently with the first sub-layer 176 and/or the second sub-layer 177. For example, the diffraction grating 126 may be written, impressed, embedded, imprinted, etched, grown, deposited or otherwise formed within the light-coupling structure 106. As shown in FIG. 3, the grating 126 is embedded within the cladding layer 171. The diffraction grating 126 includes a designated variation in the refractive index that causes the incoming light beam 120 to couple with the waveguide layer 172 as set forth herein. In the illustrated embodiment, the variation in refractive index is formed by different materials that alternate with respect to each other. More specifically, the diffraction grating 126 includes alternating portions of the cladding layer 171 and a grating material 179. The grating material 179 forms a series of ridges 184 that are separated by intervening portions of the cladding layer 171. In an exemplary embodiment, the grating material 179 comprises poly-silicon or amorphous silicon that is deposited and/or etched such that the ridges 184 are separated by the intervening portions of the cladding layer 171. However, it should be understood that the diffraction grating 126 may include other materials and may be formed through various processes.

The series of spaced-apart ridges 184 of the diffraction grating 126 may be co-planar with respect to one another. Optionally, the ridges 184 may have square or rectangular cross-sections. For example, each ridge 184 may have a height (or depth) 186 and a width (or duty cycle) 188. Adjacent ridges 184 are separated by a gap or spacing 190. The width 188 and the gap 190 may determine a period or pitch 192 of the diffraction grating 126. The period 192 may be uniform for an entirety of the first dimension 180. In alternative embodiments, the period 192 may change for predetermined portions along the first dimension 180 to achieve a desired effect. The height 186, the width 188, the gaps 190, and the material of the diffraction grating 126 include at least some of the parameters that may be configured so that the grating coupler 112 performs as desired.

In particular embodiments, the period 192 of the diffraction grating 126 is less than the wavelength of the light beam 120. The period 192 of the diffraction grating 126 may be determined by the grating coupling equation:

$$Λ = \frac{λ}{{N}_{eff} - n sin θ}$$

wherein Λ is the period 192, λ is the wavelength of the incoming light, N_{eff} is the effective index of the guided mode in the waveguide layer 172 as well as the diffraction grating 126, η is the refractive index of the second cladding layer 177, and θ is the incident angle of the incoming light with respect to the normal axis. In some embodiments, the incident angle θ may be effectively zero such that the equation can be changed to:

$$Λ = \frac{λ}{{N}_{eff}} .$$

The period 192 may be calculated by satisfying a phase match condition with respect to the waveguide layer 172. The diffraction grating 126 may be characterized as having a sub-wavelength grating period. The light beam 120 may have one or more wavelengths within a predetermined range. For example, the wavelength (or wavelengths) of the light beam 120 may be between 800 nanometers (nm) and 1600 nm. Common wavelengths used in industry may include 850 nm, 1310 nm, and 1550 nm. In particular embodiments, the period 192 may be configured to reduce an efficiency or power of the second order of diffraction. The period 192 may be less than the wavelength of the light beam or incident light. For example, the period 192 may be less than 1250 nm, less than 1125 nm, less than 1000 nm, less than 900 nm, or less than 850 nm. In particular embodiments, the period 192 may be less than 800 nm, less than 775 nm, or less than 750 nm. In more particular embodiments, the period 192 may be less than 725 nm or less than 700 nm. The period 192 may be based on other parameters of the diffraction grating 126, such as the refractive indices of the different materials that form the diffraction grating 126.

To illustrate values that may be used by embodiments set forth herein, the height 186 may be about 250 nm, the width 188 may be about 300 nm, the refractive index of the ridges 184 may be about 3.5, the refractive index of the material of the cladding layer 171 extending between the ridges 184 may be about 1.45, and the period 192 may be about 755 nm. The wavelength of the light may be about 1310 nm. However, the above values and other values noted herein are provided only to illustrate exemplary values that may be used by one or more embodiments and it should be understood that other values may be used depending upon circumstances and/or the desired application.

The diffraction grating 126 is configured such that the effectively normal light beam 120 is diffracted by the diffraction grating 126 to form first and second diffracted portions 202, 204. The first and second diffracted portions 202, 204 are directed toward the waveguide layer 172 at an angle that allows the first and second diffracted portions 202, 204 to couple with the waveguide layer 172. As shown in FIG. 3, the diffraction grating 126 is separated from the waveguide layer 172 by an operative thickness 194 of a portion of the cladding layer 171, which may be equal to a height or thickness of the first sub-layer 176. The operative thickness 194 may be configured to provide a designated coupling strength or efficiency. More specifically, the operative thickness 194 may be configured so that the first and second diffracted portions 202, 204 of the light beam 120 are coupled into the waveguide layer 172 at a designated efficiency. For example, the operative thickness 194 may be from about 100 to about 250 nm. Upon entering the waveguide layer 172, the first and second diffracted portions 202, 204 are effectively directed in the opposite first and second directions 115, 117, respectively, and into the first and second intermediate waveguides 114, 116, respectively, (FIG. 1).

The light beam 120 may be configured such that the light beam 120 includes only one polarization, either transverse electric (TE) mode or transverse magnetic (TM) mode. In an exemplary embodiment, the optical device 100 (FIG. 1) does not include an additional optical element that is positioned between the optical element 102 and the optical device 100. More specifically, an empty space may exist between an end of the optical element 102 and an outer or external surface 196 of the light-coupling structure 106. In such embodiments, the light beam 120 may exit the optical element 102 in a direction that is effectively normal with respect to the grating plane 122 (FIG. 1). The grating plane 122 may extend parallel to the substrate layers 171-174 and/or the grating 126. In alternative embodiments, the light beam 120 may be re-directed prior to entering the light-coupling structure 106. For example, a wedge-shaped element (not shown) may be positioned between the optical element 102 and the outer surface 196 of the cladding layer 171.

Although FIG. 3 illustrates one example of a grating coupler that may be used by embodiments set forth herein, it should be understood that the grating coupler 112 may be modified or changed in one or more manners and still achieve the desired effect. For example, one or more of the parameters described above may be modified. Likewise, the diffraction grating 126 may be chirped or blazed. In some embodiments, a reflective mirror may be provided within the light-coupling structure 106 that facilitates directing the first and second diffracted portions 202, 204.

FIG. 4 is an isolated view of the coupling-transition region 134, and FIG. 5 is a cross-section of the coupling-transition region 134. The coupling-transition region 134 is configured to optically couple the light-coupling structure 106 (FIG. 1) to a remainder of the optical device 100. For example, the remainder of the optical device 100 may include the base layer 174, which may be a silicon substrate. The base layer 174 may have one or more of the optical circuits 108 (FIG. 1) mounted thereon that are optically coupled to the device waveguide 136.

As shown in FIGS. 4 and 5, the coupling-transition region 134 includes an end portion 206 of the common waveguide 132. The common waveguide 132 may be formed from the waveguide layer 172 (FIG. 2). The common waveguide 132 is surrounded by the cladding layer 171. In some embodiments, the cladding layer 171 may surround the waveguide layer 172 throughout. More specifically, the cladding layer 171 may surround the first and second intermediate waveguides 114, 116 (FIG. 1) and the light-coupling portion 146 (FIG. 2).

The coupling-transition region 134 also includes an inverse taper portion 210 of the device waveguide 136. The inverse taper portion 210 is positioned adjacent to the end portion 206 of the common waveguide 132 and extends parallel to the common waveguide 132. The inverse taper portion 210 and the end portion 206 are positioned and shaped relative to each other such that the guided portion of the light is directed into the inverse taper portion 210. For instance, as shown in FIG. 5, the inverse taper portion 210 of the device waveguide 136 may have a width that is less than a width of the common waveguide 132. Comparing FIGS. 4 and 5, the width of the inverse taper portion 210 may gradually become larger than the width of the common waveguide 132. The guided portion then propagates through the device waveguide 136 to the remainder of the optical device 100.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

As used in the description, the phrase “in an exemplary embodiment” and the like means that the described embodiment is just one example. The phrase is not intended to limit the inventive subject matter to that embodiment. Other embodiments of the inventive subject matter may not include the recited feature or structure. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f), unless and until such claim limitations expressly use the phrase “means for” followed by a statement of function void of further structure.

What is claimed is:

1. A light-coupling structure comprising:
a grating coupler configured to optically couple with an optical element, the grating coupler having a diffraction grating that extends parallel to a grating plane, the grating coupler configured to diffract a light beam into first and second diffracted portions when the light beam is directed from the optical element to the grating coupler and is effectively normal to the grating plane, the first and second diffracted portions propagating away from each other;
first and second intermediate waveguides optically coupled to the grating coupler and configured to receive the first and second diffracted portions, respectively, from the grating coupler; and
a common waveguide coupled to the first and second intermediate waveguides at a waveguide junction, wherein the first and second diffracted portions propagating within the first and second intermediate waveguides, respectively, are combined in-phase at the waveguide junction.

2. The light-coupling structure of claim 1, wherein the light beam is effectively normal with respect to the grating plane when the light beam is within about 5.0° of being normal with respect to the grating plane.

3. The light-coupling structure of claim 1, wherein the first and second intermediate waveguides are formed from a waveguide layer, the waveguide layer also forming a light-coupling portion that extends alongside the diffraction grating, the diffraction grating configured to direct the first and second diffracted portions into the light-coupling portion, the first and second diffracted portions propagating in the opposite directions within the light-coupling portion.

4. The light-coupling structure of claim 3, wherein the grating coupler includes a cladding layer that extends alongside the waveguide layer, the diffraction grating being embedded within the cladding layer such that a portion of the cladding layer extends between the diffraction grating and the waveguide layer.

5. The light-coupling structure of claim 3, wherein the diffraction grating is separated from the waveguide layer by a cladding sub-layer.

6. The light-coupling structure of claim 1, wherein the diffraction grating has a grating period that is less than a wavelength of the light beam.

7. The light-coupling structure of claim 1, wherein the diffraction grating has a grating period that is less than 1000 nanometers.

8. The light-coupling structure of claim 1, wherein the first and second intermediate waveguides have equal path lengths between the grating coupler and the waveguide junction.

9. The light-coupling structure of claim 1, wherein the grating coupler, the first and second intermediate waveguides, and the common waveguide are formed through at least one of a silicon-on-insulator (SOI) process or a complementary metal-oxide-semiconductor (CMOS) process.

10. The light-coupling structure of claim 1, further comprising a device waveguide having an inverse taper portion that is optically coupled to the common waveguide.

11. The light-coupling structure of claim 1, wherein the waveguide junction is a Y-junction.

12. The light-coupling structure of claim 1, wherein the first and second intermediate waveguides include first and second tapered segments, respectively, that receive the first and second diffracted portions, respectively, the first and second tapered segments reducing in size as the first and second tapered segments extend away from the grating coupler.

13. An optical device comprising:
a grating coupler configured to optically couple with an optical element, the grating coupler having a diffraction grating that extends parallel to a grating plane, the grating coupler configured to diffract a light beam into first and second diffracted portions when the light beam is directed from the optical element to the grating coupler and is effectively normal to the grating plane, the first and second diffracted portions propagating away from each other;
first and second intermediate waveguides optically coupled to the grating coupler and configured to receive the first and second diffracted portions, respectively, from the grating coupler;
a common waveguide coupled to the first and second intermediate waveguides at a waveguide junction, wherein the first and second diffracted portions propagating within the first and second intermediate waveguides, respectively, are combined in-phase at the waveguide junction to form a guided portion; and
an optical circuit that is optically coupled to the common waveguide, the optical circuit configured to process the guided portion in a designated manner.

14. The optical device of claim 13, wherein the light beam is effectively normal with respect to the grating plane when the light beam is within about 6.0° of being normal with respect to the grating plane.

15. The optical device of claim 13, wherein the first and second intermediate waveguides are formed from a waveguide layer, the waveguide layer also forming a light-coupling portion that extends alongside the diffraction grating, the diffraction grating configured to direct the first and second diffracted portions into the light-coupling portion, the first and second diffracted portions propagating in the opposite directions within the light-coupling portion.

16. The optical device of claim 15, wherein the grating coupler includes a cladding layer that extends alongside the waveguide layer, the diffraction grating being embedded within the cladding layer such that a portion of the cladding layer extends between the diffraction grating and the waveguide layer.

17. The optical device of claim 15, wherein the diffraction grating is separated from the waveguide layer by a cladding sub-layer.

18. The optical device of claim 13, wherein the optical circuit includes a modulator.

19. The optical device of claim 13, wherein the first and second intermediate waveguides have symmetrical paths between the grating coupler and the waveguide junction.

20. The optical device of claim 13, wherein the optical device is a photonic integrated circuit.
